(19) United States
(12) Patent Application Publication
(10) Pub. No.: US 2023/0334299 A1
(43) Pub. Date: Oct. 19, 2023

(54) TIME SERIES DATA SET SIMULATION

(71) Applicant: The Bank of New York Mellon, New York, NY (US)

(72) Inventors: Mohit JAIN, Princeton, NJ (US); Srishti KUMAR, Bordentown, NY (US)

(73) Assignee: THE BANK OF NEW YORK MELLON, New York, NY (US)

(21) Appl. No.: 17/720,966

(22) Filed: Apr. 14, 2022

(51) Int. Cl. G06N 3/04; G06N 3/08

(52) U.S. Cl. CPC G06N 3/049; G06N 3/0454; G06N 3/088

(57) ABSTRACT

Provided is a method including obtaining a plurality of time series data sets and a synthetic time series data set that is associated with a first machine learning label such that the first machine learning label is associated with a first time series data set of the plurality of time series data sets. The method includes inputting the synthetic time series data set, the first machine learning label, a second machine learning label that is associated with a second time series data set of the plurality of time series data sets, and a series of generated values in a time series simulation machine learning model that includes a trained generative adversarial network. The method includes running a generator neural network included in the trained generative adversarial network with the inputs and then generating a synthetic second time series data set for the second time series data set.

### BACKGROUND

### 1. Field

The present disclosure relates generally to data simulation and machine learning.

### 2. Description of the Related Art

Time series data may be modeled to predict a property associated with that data. For example, manufacturing data, energy storage data, pharmaceutical data, weather data, climate data, financial market data, and/or other time series data may be used to predict a particular property that is associated with the time series data. Many models for predicting a property associated with the time series data have been developed. For example, many models are based on a normal distribution of the data. Other models may use fractals. In any case, creating models for predicting a property of a time series data set is important to many industries.

### SUMMARY

The following is a non-exhaustive listing of some aspects of the present techniques. These and other aspects are described in the following disclosure.

Some aspects include a process including obtaining, by a computing system, a first synthetic time series data set that is associated with a first machine learning label; inputting, by the computing system, the first machine learning label, the first synthetic time series data set, a second machine learning label, and a first series of generated values into a first generator neural network included in a first generative adversarial network; inputting, by the computing system, the first machine learning label, the first synthetic time series data set, the second machine learning label, a first real time series data set that is associated with the second machine learning label, and a second synthetic time series data set that is associated with the second machine learning label and that is outputted from the first generator neural network into a first discriminator neural network included in the first generative adversarial network; running, by the computing system, the first generative adversarial network until the second synthetic time series data set is determined to satisfy a first evaluation condition by the first discriminator neural network; generating, by the computing system, a time series simulation machine learning model that includes the first generative adversarial network that includes first model parameters that resulted in the first generative adversarial network producing the second synthetic time series data set that satisfied the evaluation condition; and storing, by the computing system, the time series simulation machine learning model in a storage system coupled to the computing system.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

Some aspects include a process including obtaining, by a computing system, a data object that includes a plurality of time series data sets; obtaining, by the computing system, a first synthetic time series data set that is associated with a first machine learning label, wherein the first machine learning label is associated with a first time series data set of the plurality of time series data sets; inputting, by the computing system, the first synthetic time series data set, the first machine learning label, a second machine learning label that is associated with a second time series data set of the plurality of time series data sets, and a first series of generated values in a time series simulation machine learning model that includes a first trained generative adversarial network that includes first model parameters; running, by the computing system, the time series simulation machine learning model that includes running a first generator neural network included in the first trained generative adversarial network with the first synthetic time series data set, the first machine learning label, the second machine learning label, and the first series of generated values; generating, by the computing system via the running of the time series simulation machine learning model, a synthetic second time series data set for the second time series data set; and storing, by the computing system, the synthetic second time series data set in a storage system.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram illustrating an example of a time series data set simulation system, in accordance with some embodiments of the present disclosure;

FIG. 2 is a block diagram illustrating an example of a time series simulation computing device of the time series data set simulation system of FIG. 1, in accordance with some embodiments of the present disclosure;

FIG. 3 is a flow chart illustrating an example of a method of the time series data set simulation system, in accordance with some embodiments of the present disclosure;

FIG. 4 illustrates a block diagram of a time series data set simulation model during some embodiments of the method of FIG. 3, in accordance with some embodiments of the present disclosure;

FIG. 5 illustrates a block diagram of training a base generative adversarial network (GAN) of the time series data set simulation model of FIG. 4, in accordance with some embodiments of the present disclosure;

FIG. 6 illustrates a block diagram of training a coupled GAN of the time series data set simulation model of FIG. 4, in accordance with some embodiments of the present disclosure;

FIG. 7 illustrates a block diagram of a workflow of a generator neural network included in the base GAN, in accordance with some embodiments of the present disclosure;

FIG. 8 illustrates a block diagram of a workflow a discriminator neural network included in the base GAN, in accordance with some embodiments of the present disclosure;

FIG. 9 illustrates a block diagram of a workflow of a generator neural network included in the coupled GAN, in accordance with some embodiments of the present disclosure;

FIG. 10 illustrates a block diagram of a workflow of a discriminator neural network included in the coupled GAN, in accordance with some embodiments of the present disclosure;

FIG. 11 illustrates a graphical representation of a plot of a time series data set and a corresponding synthetic time series data set, in accordance with some embodiments of the present disclosure.

FIG. 12 illustrates a graphical representation of plots of two different synthetic time series data sets when generated, using a GAN, independently from each other, in accordance with some embodiments of the present disclosure.

FIG. 13 is a block diagram of an example of a computing system with which the present techniques may be implemented, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

Because solutions to multiple problems are addressed herein, it should be understood that some embodiments are problem-specific, and not all embodiments address every problem with traditional systems described herein or provide every benefit described herein. That said, improvements that solve various permutations of these problems are described below.

Models of time series data tend to follow a normal distribution, also referred to as the bell curve and the Gaussian distribution. Many phenomena in the natural and human-made world follow a normal distribution, for example—the height and weight distribution in a population, distribution of seasonal temperature, SAT, and IQ scores among others. One of the most noteworthy parts of this distribution is that it can be described by using just two parameters: mean (μ) and standard deviation (σ).

Since the normal distribution for modelling is so popular, financial modelling initially also borrowed the concept in predicting financial market performance. One such normal distribution model includes a modern portfolio theory developed by Harry Markowitz. Other normal distribution models include the capital asset pricing model (CAPM). Its intention is to calculate the relationship between systemic risk_(undiversifiable risk or market risk) and expected returns for a particular asset. Another financial model, which is widely adopted in financial industry is the Black-Scholes model, used for pricing options by valuating the risk of the security.

The underlying principle of all these models is that a stock's inherent risk or volatility can be determined by the bell-curve or normal distribution. These models also assume that one day, week, month and year's price is independent of another day, week, month or year's price. In statistical terms it is also known as independent and identically distributed random variables.

However, various time series scenarios do not always follow a normal distribution including financial markets, pharmaceuticals, manufacturing scenarios, weather and climate and other scenarios. Often, there are events that occur in the time series data associated with the scenarios that are highly unlikely with respect to the normal distribution (e.g., major moves in the stock market, an injury or some other environmental event that occurs to a subject taking a drug, severe temperature swing, or other events). While these events do not occur very frequently, it has been found that they do produce a significant effect on the overall property that is being measured from the model, and thus are not insignificant, which makes predictions of a property that rely on a normal distribution of the underlying data inaccurate because these events are often ignored.

As such, other models that do not follow a normal distribution have been developed using the properties of fractals. Other examples, include generalized autoregressive conditional heteroskedasticity (GARCH) models describe time series data sets in which volatility can change, becoming more volatile during periods of crises or events and less volatile during periods of relative calm and steadiness. On a plot of returns, for example, stock returns may look relatively uniform for the years leading up to a financial crisis such as that of 2007. Often mean-variance optimization techniques are employed as well. These place too much certainty on one set of return assumptions that depict only one economic and market scenario.

The systems and methods of the present disclosure use machine learning to create realistic time series data sets. It is an empirical approach more ingrained in mimicking the behavior of an actual time series data set (e.g., a real time series data set that is associated with a measurement of an environment or a synthesized time series data set that is treated as “real”). The systems and methods of the present disclosure attempt to mimic real time series data sets. Aspects of the present disclosure use machine learning algorithm called generative adversarial networks (GANs). The underlying logic of how GANs work can be understood by drawing an analogy—a tug of war between a faker creating a fake item and a fraud investigator. Initially, the faker is not good at creating fake item, as well as the investigator is learning how to detect fake items. So, both go to a training. The investigator learns how to detect fakes by observing some real items. On the other hand, the faker creates some items and shows it to the investigator to see if the investigator can differentiate between real and fake. The caveat is that the faker has never seen the real items and depends on the investigator's input. Since the investigator has seen the real items, he tells the faker that item is fake and also gives the faker some clues on why the item is a fake. With time/training the faker improves upon creating fake items and investigator improves upon detecting the fake items. This process goes on for a while until the faker gets so good in creating the fake items that investigator can no longer differentiate between a fake and a real item.

In actual machine learning, the faker and investigator may be substituted with two neural networks—mathematical functions used in machine learning—in case of generating synthetic data using GANs. GANs are agnostic to applications and now routinely used in creating “fake” faces, videos, and voices by training on real data. Currently, they are at a worrisome point where it can be difficult to distinguish between real and fake data. In the present disclosure, the goal is to use synthetic data, generated by GANs, to perform simulations that test a property of a scenario associated with a time series data set. This contrasts with simulations where properties or metrics are generated using a normal distribution and single expected return and expected risk values are used as inputs.

Research in the field of simulating market index data using generative architecture is limited. Prior research in this field has mainly focused on capturing the inherent features of one of these market indexes. Such approaches leave behind a gap where a single model captures/addresses the variations of a single market index but are operationally expensive and not effectively scalable. Because training GANs is extremely difficult and unstable, therefore, to build a scalable solution, it is imperative to have minimum number of models to train and maintain.

However, it has been found that only simulating independent time series data sets is not enough to capture the true behavior as they may or may not follow the real-world inter-time series data set relationships. Due to this, there is a need to have multiple generated time-series data which represent different parameters of the use-case or application. There has been some research around generating multiple market indexes, but the involved computational complexity in such methodologies is directly proportional to the number of data sets being considered and the number of days being selected to model input and output. It is also more relevant to use-cases where the GAN is expected to simulate shorter time series, generally with a tradeoff between number of data sets and the length of time-period being simulated.

Research in the field of generating such time-series data aim to generate only a single synthetic time series data set. However, the systems and method of the present disclosure prescribes to create and tune as many generative models as the number of time series data sets one wants for their purpose. In one example of the present disclosure, the same methodology is extended to simulating market volatility as well, where to generate a synthetic set of market index, multiple models need to be trained to simulate a secondary market index based on a primary market index. The primary and secondary terminology refers to the index used as an input and the index that was generated respectively.

The systems and methods of the present disclosure solve this problem by training a generative model to mimic real world time series data sets and generate properties for multiple time series data sets without involving the complexity of building, training, tuning, and maintaining individual models that mimic a time series data set. The results thus obtained from the generative models described herein do not compromise on quality and bear close resemblance to the trends and features from the real-world time series data sets.

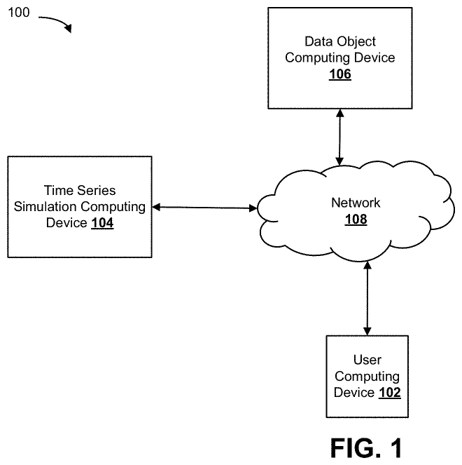

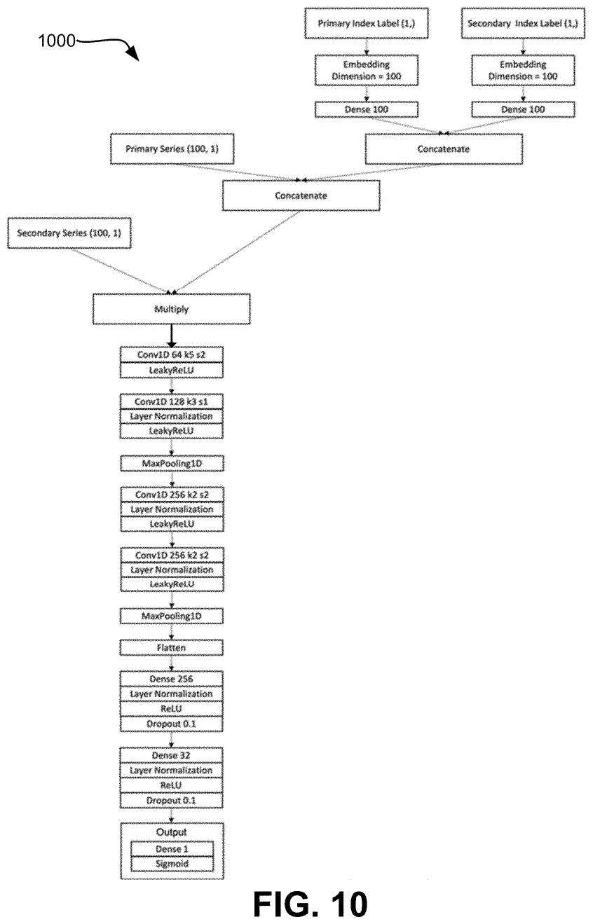

FIG. 1 depicts a block diagram of an example of a time series data set simulation system 100, consistent with some embodiments. In some embodiments, the time series data set simulation system 100 may include a user computing device 102, a time series simulation computing device 104, and a data object provider computing device 106. The user computing device 102 and the time series simulation computing device 104 may be in communication with each other over a network 108. In various embodiments, the user computing device 102 may be associated with a user (e.g., in memory of the time series data set simulation system 100 in virtue of user profiles). These various components may be implemented with computing devices like that shown in FIG. 10.

In some embodiments, the user computing device 102 may be implemented using various combinations of hardware or software configured for wired or wireless communication over the network 108. For example, the user computing device 102 may be implemented as a wireless telephone (e.g., smart phone), a tablet, a personal digital assistant (PDA), a notebook computer, a personal computer, a connected set-top box (STB) such as provided by cable or satellite content providers, or a video game system console, a head-mounted display (HIVID), a watch, an eyeglass projection screen, an autonomous/semi-autonomous device, a vehicle, a user badge, or other user computing devices. In some embodiments, the user computing device 102 may include various combinations of hardware or software having one or more processors and capable of reading instructions stored on a tangible non-transitory machine-readable medium for execution by the one or more processors. Consistent with some embodiments, the user computing device 102 includes a machine-readable medium, such as a memory that includes instructions for execution by one or more processors for causing the user computing device 102 to perform specific tasks. In some embodiments, the instructions may be executed by the one or more processors in response to interaction by the user. One user computing device is shown, but commercial implementations are expected to include more than one million, e.g., more than 10 million, geographically distributed over North America or the world.

The user computing device 102 may include a communication system having one or more transceivers to communicate with other user computing devices or the time series simulation computing device 104. Accordingly, and as disclosed in further detail below, the user computing device 102 may be in communication with systems directly or indirectly. As used herein, the phrase “in communication,” and variants thereof, is not limited to direct communication or continuous communication and may include indirect communication through one or more intermediary components or selective communication at periodic or aperiodic intervals, as well as one-time events.

For example, the user computing device 102 in the time series data set simulation system 100 of FIG. 1 may include a first (e.g., relatively long-range) transceiver to permit the user computing device 102 to communicate with the network 108 via a communication channel. In various embodiments, the network 108 may be implemented as a single network or a combination of multiple networks. For example, in various embodiments, the network 108 may include the Internet or one or more intranets, landline networks, wireless networks, or other appropriate types of communication networks. In another example, the network 108 may comprise a wireless telecommunications network adapted to communicate with other communication networks, such as the Internet. The wireless telecommunications network may be implemented by an example mobile cellular network, such as a long-term evolution (LTE) network or other third generation (3G), fourth generation (4G) wireless network, fifth generation (5G) wireless network or any subsequent generations. In some examples, the network 108 may be additionally or alternatively be implemented by a variety of communication networks, such as, but not limited to (which is not to suggest that other lists are limiting), a satellite communication network, a microwave radio network, or other communication networks.

The user computing device 102 additionally may include second (e.g., short-range relative to the range of the first transceiver) transceiver to permit the user computing device 102 to communicate with each other or other user computing devices via a direct communication channel. Such second transceivers may be implemented by a type of transceiver supporting short-range (i.e., operate at distances that are shorter than the long-range transceivers) wireless networking. For example, such second transceivers may be implemented by Wi-Fi transceivers (e.g., via a Wi-Fi Direct protocol), Bluetooth® transceivers, infrared (IR) transceivers, and other transceivers that are configured to allow the user computing device 102 to communicate with each other or other user computing devices via an ad-hoc or other wireless network.

The time series data set simulation system 100 may also include or may be in connection with the time series simulation computing device 104. For example, the time series simulation computing device 104 may include one or more server devices, storage systems, cloud computing systems, or other computing devices (e.g., desktop computing device, laptop/notebook computing device, tablet computing device, mobile phone, etc.). In various embodiments, time series simulation computing device 104 may also include various combinations of hardware or software having one or more processors and capable of reading instructions stored on a tangible non-transitory machine-readable medium for execution by the one or more processors. Consistent with some embodiments, the time series simulation computing device 104 includes a machine-readable medium, such as a memory (not shown) that includes instructions for execution by one or more processors (not shown) for causing the time series simulation computing device 104 to perform specific tasks. In some embodiments, the instructions may be executed by the one or more processors in response to interaction by the user. The time series simulation computing device 104 may also be maintained by an entity with which sensitive credentials and information may be exchanged with the user computing device 102. The time series simulation computing device 104 may further be one or more servers that hosts applications for the user computing device 102. The time series simulation computing device 104 may be more generally a web site, an online content manager, a service provider, a healthcare records provider, an electronic mail provider, a title insurance service provider, a datacenter management system, a financial institution or other entity that generates or uses data objects that includes time series data.

The time series simulation computing device 104 may include various applications and may also be in communication with one or more external databases, that may provide additional information or data objects that may be used by the time series simulation computing device 104. For example, the time series simulation computing device 104 may obtain, via the network 108, data objects from a data object provider computing device 106 that may obtain or generate data objects that include time series data for the time series simulation computing device 104. While a specific time series data set simulation system 100 is illustrated in FIG. 1, one of skill in the art in possession of the present disclosure will recognize that other components and configurations are possible, and thus will fall under the scope of the present disclosure.

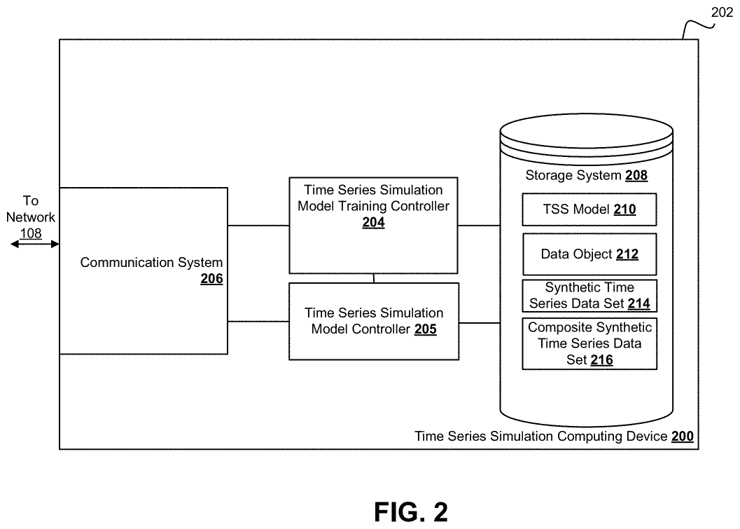

FIG. 2 depicts an embodiment of a time series simulation computing device 200, which may be the time series simulation computing device 104 discussed above with reference to FIG. 1. In the illustrated embodiment, the time series simulation computing device 200 includes a chassis 202 that houses the components of the time series simulation computing device 200, only some of which are illustrated in FIG. 2. For example, the chassis 202 may house a processing system (not illustrated) and a non-transitory memory system (not illustrated) that includes instructions that, when executed by the processing system, cause the processing system to provide a time series simulation model training controller 204 that is configured to perform the functions of the time series simulation model training controllers, or the time series simulation computing devices discussed below. Specifically, the time series simulation model training controller 204 may train a time series simulation model used to simulate time series data and make predictions based on the simulated time series data, as discussed in further detail below.

The processing system and the non-transitory memory system may also include instructions that, when executed by the processing system, cause the processing system to provide a time series simulation model controller 205 that is configured to perform the functions of the time series simulation model controller, or the time series simulation computing device discussed below. For example, the time series simulation model controller 205 may use data objects that include time series data entries to make predictions of a property associated with the time series data entries using various machine learning algorithms and artificial intelligence, as discussed in further detail below. The time series simulation model controller 205 may be configured to provide time series simulations and predications that include time series data entries over the network 108 to the user computing device 102. For example, the user of the user computing device 102 may interact with the time series simulation model controller 205 through a native application or web browser included on the user computing device 102 over the network 108 to request information, conduct a commercial transaction, store or retrieve data objects, obtain computer system component usage metrics, obtain financial data sets, receive a prediction of a parameter for which a machine learning algorithm is predicting, or otherwise interact with the time series simulation model controller 205.

The chassis 202 may further house a communication system 206 that is coupled to the time series simulation model controller 205 (e.g., via a coupling between the communication system 206 and the processing system) and that is configured to provide for communication through the network 108 of FIG. 1 as detailed below. The communication system 206 may allow the data time series simulation computing device 200 to send and receive information over the network 108 of FIG. 1. The chassis 202 may also house a storage device (not illustrated) that provides a storage system 208 that is coupled to the time series simulation model controller 205 through the processing system. The storage system 208 may be configured to store time series simulation models 210, data objects 212 that include time series data sets, synthetic time series data sets 214, composite synthetic time series data sets 216, or other data or instructions to complete the functionality discussed herein. In various embodiments, the storage system 208 may be provided on the time series simulation computing device 200 or on a database accessible via the communication system 206. Furthermore, while the time series simulation model training controller 204 or the time series simulation model controller 205 are illustrated as being located on the time series simulation computing device 104/200, the time series simulation model training controller 204 or the time series simulation model controller 205 may be included on the data object provider computing device 106 of FIG. 1. For example, the time series simulation model controller 205 may obtain a data object or a portion of the data object that includes time series data from itself rather than over a network from the data object provider computing device 106.

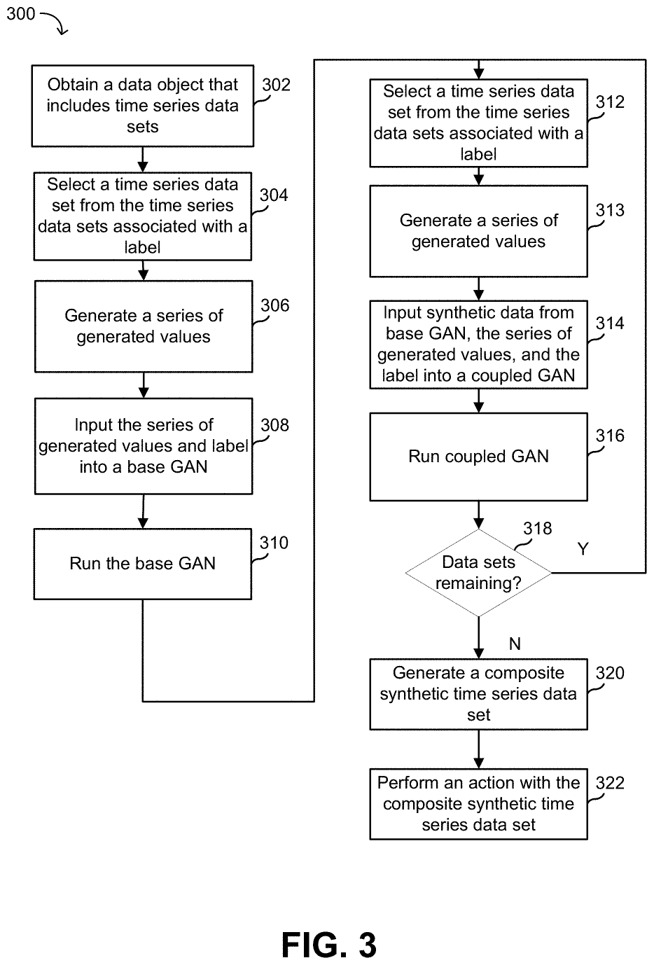

FIG. 3 depicts an embodiment of a method 300 of time series simulation and prediction, which in some embodiments may be implemented with at least some of the components of FIGS. 1 and 2 discussed above. As discussed below, some embodiments make technological improvements to data object analysis and machine learning predictions using data objects that include time series data entries. In a variety of scenarios, the systems and methods of the present disclosure train a generative model to mimic real world time series data sets and generate properties for multiple time series data sets without involving the complexity of building, training, tuning, and maintaining individual models that mimic a time series data set. By using multiple GANs that are each trained for a plurality of time series data sets and unique preprocessing inputs to those GANs, the results thus obtained from the generative models described herein do not compromise on quality and bear close resemblance to the trends and features from the real-world time series data sets.

The method 300 is described as being performed by the time series simulation model training controller 204 or the time series simulation model controller 205 included on the time series simulation computing device 104/200. Furthermore, it is contemplated that the user computing device 102 or the data object provider computing device 106 may include some or all the functionality of the time series simulation model training controller 204 or the time series simulation model controller 205. As such, some or all of the steps of the method 300 may be performed by the user computing device 102 or the data object provider computing device 106 and still fall under the scope of the present disclosure. As mentioned above, the time series simulation computing device 104/200 may include one or more processors or one or more servers, and thus the method 300 may be distributed across the those one or more processors or the one or more servers.

The method 300 may begin at block 302 where a data object that includes a plurality of time series data sets is obtained. In an embodiment, at block 302, the time series simulation model controller 205 may obtain a data object 212 that includes a plurality of time series data sets. In various embodiments, the time series simulation model controller 205 may obtain the data object from an internal application that generates time series data sets or from one or more data object provider computing devices 106.

In various embodiments, each time series data set may be associated with a weight that defines how the time series data set relates to the other time series data sets within the data object. Also, in various embodiments, each time series data set may be associated with a label for that time series data set, and each time series data set may be associated with a variable that is being measured over a time period. The variable may be associated with one or more properties (also referred to as a metric herein) that may be related to the variable.

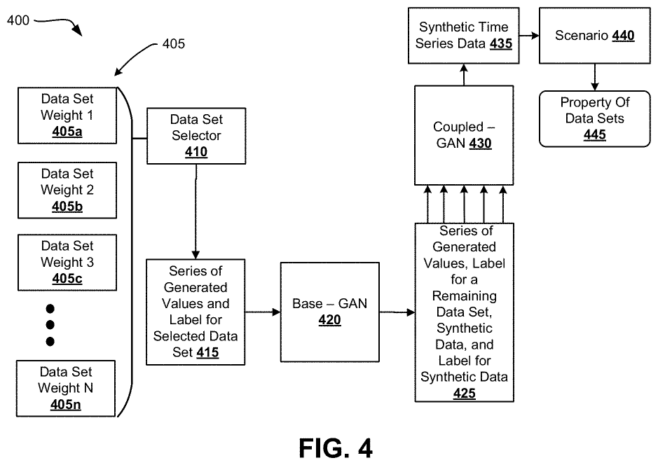

FIG. 4 illustrates an example workflow of a time series simulation model 400 of the present disclosure. As illustrated, the time series simulation model controller 205 may have obtained the data object 405 that may be a data object 212 of FIG. 2. The data object 405 may include a data set 405a having a first weight, a data set 405b having a second weight, a data set 405c having a third weight, and up to a data set 405n having an nth weight. However, one of skill in the art will recognize that fewer or more data sets may be included in the data object 405. A data set of the data sets 405a-405n may include time series data sets and may include a label for that data set. Each data set 405a-405n may be related to a property (e.g., a property 445) for which the time series simulation model 400 is attempting to predict.

The time series simulation model 400 may be used for various time series data objects and for predicting various properties. For example, the time series simulation model 400 may be used in manufacturing applications, climatology applications, energy applications, financial applications. In a specific example, the time series simulation model 400 may be trained for manufacturing an electric charge storage device such as a battery. The data object may include data sets that are associated with costs of various components of the battery and each data set may include a weight. The property associated with the data sets may include cost per kilowatt hour.

In another example, the time series simulation model 400 may be trained for manufacturing pharmaceuticals. The data object may include data sets that are associated with functional groups and each data set may include a weight. The property associated with the data sets may include long-term efficacy of a particular proposed molecule.

In another example, the time series simulation model 400 may be trained for climate and weather pattern predictions. The data object may include data sets that are associated with various factors for a region over time (e.g., carbon dioxide concentration, pressure, humidity, vegetation cover, methane concentration, ozone cover or other conditions). The property associated with the data sets may include atmospheric temperature of a region.

In another example, the time series simulation model 400 may be trained for asset management. The data object may include data sets that are associated with portfolio groups (e.g., a large cap group, a small cap group, a mid-cap group, a treasury bill group, an emerging market group, a real estate group, or other groups) and each data set may include a weight (e.g., percent of the portfolio that portfolio group represents). The property associated with each data set may include daily returns. In some examples, instead of groups, the portfolio may be analyzed based on individual companies' performance over time for each data set. While some examples of scenarios where time series data may exist, one of skill in the art in possession of the present disclosure will recognize that other scenarios exist, and the systems and methods of the present disclosure are not limited to the scenarios discussed above.

The method 300 may proceed to block 304 where a time series data set of the plurality of time series data sets included in the data object is selected. In an embodiment, at block 304, the time series simulation model controller 205 may select a time series data set that is included in the data object 212. For example, the time series simulation model controller 205 may include a data set selector 410, as illustrated in FIG. 4, that is configured to select a data set included in the data object. In an example, the data set selector 410 may include a random number generator that generates a number that is substantially random where the number generated is an integer that is between “1” and the number of data sets included in the data object. However, in other embodiments, the data set selector 410 may select the first data set in the data object, the last data set in the data object, the data set with the greatest weight, the data set with the least weight, or may select the data set according to any other criteria that would be apparent to one of skill in the art in possession of the present disclosure. The selected time series data set may be associated with a label. The label may identify or otherwise describe the time series data set. The label may include a machine learning label such that the label may be used in machine learning algorithms.

The method 300 may then proceed to block 306 where a series of generated values is generated. In an embodiment, at block 306, the time series simulation model controller 205 may generate a series of generated values. In some examples, the series of generated values may include Gaussian noise. However, the series of generated values may include a series of generated values generated by any random number generator or pseudorandom number generator. While the series of generated values may be referred to as random, one of skill in the art will recognize that “random” may not be limited to truly random instances as even random number generators do have some degree of predictability. As illustrated in FIG. 4, the time series simulation model controller 205 may include a synthetic data generator 415 that may generate the series of generated values.

The method 300 may then proceed to block 308 where the series of generated values and the machine learning label associated with the selected data set is inputted into a base generative adversarial network (GAN). In an embodiment, at block 308, the time series simulation model controller 205 may input the series of generated values into the base GAN. In some examples, the Gaussian noise along with a flattened embedding of the label may be multiplied together prior to being inputted into the base GAN. The base GAN may be included in a time series simulation machine learning model (e.g., the time series simulation model 210 of FIG. 2) that includes the base GAN and a coupled GAN. The base GAN and the coupled GAN include respective model parameters that are optimized during training.

As illustrated, in FIG. 4. the series of generated values may be provided by the synthetic data generator 415 along with the label for the selected to a base GAN 420. Also, as illustrated, the time series simulation model 400 may include a coupled GAN 430 as indicated above. The base GAN 420 and the coupled GAN 430 are trained for each time series data set of the plurality of time series data sets 405a-405n. In various embodiments, the base GAN 420 may be trained by the time series simulation model training controller 204.

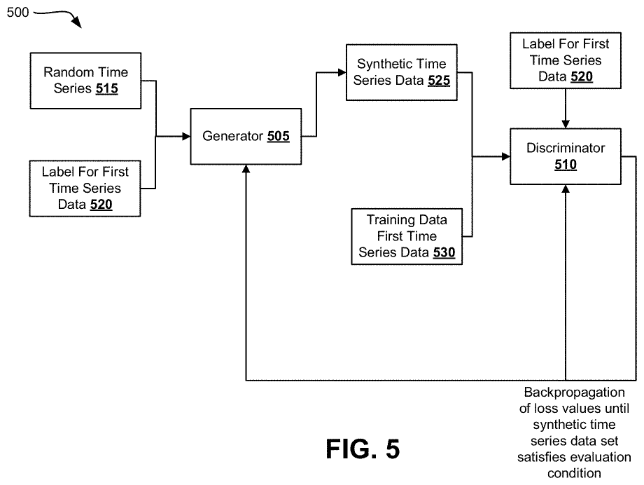

For example, FIG. 5 illustrates a training workflow of a base GAN 500 that may be provided by the base GAN 420. The base GAN 500 may include a generator neural network 505 and a discriminator neural network 510. As would be appreciated by one of skill in the art in possession of the present disclosure, GANs are highly adaptive and can be trained to learn several data distributions and generate its synthetic counterpart, which can then be used in downstream applications. A basic conventional GAN architecture includes two neural networks (e.g., the generator neural network 505 and the discriminator neural network 510). The base GAN 500 may include generator neural network 505 that takes random noise 515 (e.g., the series of generated values) and a label 520 of a training data set as inputs and learns to generate outputs (e.g., a synthetic time series data set 525) that aim to resemble the actual data set (e.g., the training data set 530) associated with the label 520 without seeing the training data set 530 that is associated with the label 520.

The discriminator neural network 510 takes as input, the actual data (e.g., the training data set 530) as well as the synthetic time series data set 525 from the generator neural network 505 labelled as “real” and “fake,” respectively and learns to distinguish “real” from “fake.” In some embodiments, the “real” label and the “real” training data set 530 may alternate with the “fake” label and the synthetic time series data set 525 when provided to the discriminator neural network 510. Periodically (e.g., 10% of the time or some other percentage), the training data set 530 may be labeled with the “fake” label and the synthetic time series data set 525 may be a labeled with the “real.” The discriminator neural network 510 also receives the label 520 associated with the training data set 530. The feedback on the synthetic time series data set 525 from the discriminator neural network 510 gets passed on to the generator neural network 505 as a loss value. The generator neural network 505 may then optimize its weights to minimize this loss value which leads it to creating a better synthetic time series data set 525 that can fool the discriminator neural network 510 into predicting it as real. At the same time the discriminator neural network 510 is trying to maximize its probability of correctly predicting the real and fake labels. Both the models are trained alternatively, and progress at such a pace that no one model should get better than the other to maintain the competition. The model training can be said to have converged once the generator neural network 505 is producing high quality data and the discriminator neural network 510 is not able to confidently distinguish “real” from “fake” or when some other condition is satisfied (e.g., within a statistical threshold of similarity between the fake and the real is achieved).

Subsequently, the synthetic time series data set 525 may be authentic and does not pre-exist in its entirety. As such, the synthetic time series data set 525 may not be compared to an existing ground truth. As such, the synthetic time series data set 525 becomes challenging to evaluate its quality. To address this model evaluation problem, in addition to manually perceiving the generated output visualizations via the user computing device 102, the time series simulation model training controller 204 may obtain descriptive statistical measures from the training data set 530 to compare and benchmark the synthetic time series data set 525 quality. The convergence of the base GAN 500 does not guarantee quality results. Therefore, the training process may be designed to save intermediary models, which are then evaluated per a combination of statistical as well as empirical methods. For example, to evaluate this generated data, a comparison of the distribution and other statistical measures like mean and variance is performed to evaluate its closeness to real world scenarios. The spread of the random scenarios is measured to have diversity by calculating the probability of the last value from synthetic data being greater or less than the last value from actual data. The models that qualify all the above criteria can be selected and be assumed to generate good real-world scenarios.

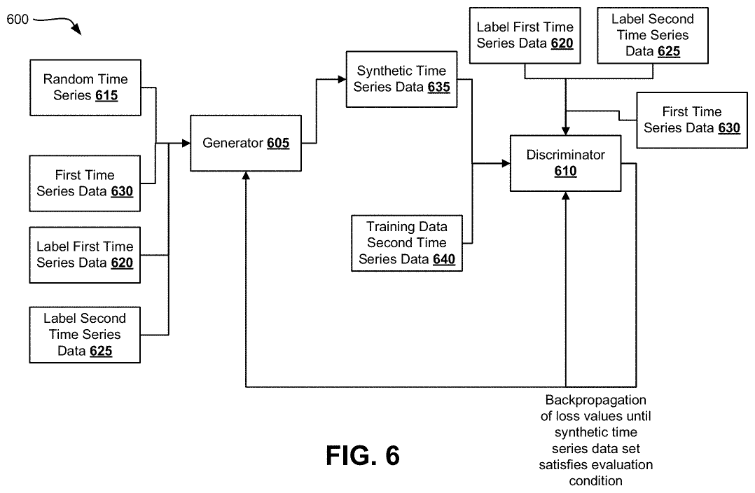

While the coupled GAN is discussed in more detail below, the coupled GAN 430 may be trained by the time series simulation model training controller 204 as well. FIG. 6 illustrates a training workflow of a coupled GAN 600 that may be provided by the coupled GAN 430. In various embodiments, the coupled GAN 600 may be trained similar to the base GAN 500. As illustrated in FIG. 6, the coupled GAN 600 may include a generator neural network 605 and a discriminator neural network 610. The generator neural network 605 receives Gaussian noise or some other substantially random time series 615 and the additional inputs such as, for example, a label 620, which may include the label 520 of FIG. 5, a label 625 that is associated with the time-series data set that the generator neural network 605 is attempting to mimic, and a time series data set 630 that is associated with the label 620 and that has a relationship with the time series data set that is associated with the label 625. In some embodiments, the time series data set 630 may include the synthetic time series data set 525 that is generated during the training of the base GAN 420/500. The generator neural network 605 generates a synthetic time series data set 635. The discriminator neural network 610 may receive the synthetic time series data set 635 as well as a training time series data set 640 that may include the actual time series data set (as used herein actual may include real data measured from the associated environment or it may include another synthetic data set that is being analyzed). The discriminator neural network 610 may also receive the label 620, the label 625, and the time series data set 630. The feedback on the synthetic time series data set 635 from the discriminator neural network 610 gets passed on to the generator neural network 605 as a loss value. The generator neural network 605 may then optimize its weights to minimize this loss value which leads it to creating a better synthetic time series data set 635 that can fool the discriminator neural network 610 into predicting it as real. At the same time, the discriminator neural network 610 is trying to maximize its probability of correctly predicting the “real” and “fake” labels and learns to distinguish “real” from “fake”. In some embodiments, the “real” label and the “real” training data set 640 may alternate with the “fake” label and the synthetic time series data set 635 when provided to the discriminator neural network 610. Periodically, the training data set 640 may be labeled with the “fake” label and the synthetic time series data set 635 may be a labeled with the “real.” The model training may converge once the generator neural network 605 is producing high quality data and the discriminator neural network 610 is not able to confidently distinguish “real” from “fake.” However, model training may converge when some other condition is satisfied (e.g., within a statistical threshold of similarity between the fake and the real

The time series simulation model training controller 204 may include an optimizer to perform the training and to optimize weights of the neural networks of the GANs 500 and 600. Also, learning rates may be set for the generator neural networks 505 and 605 and the discriminator neural network 510 and 610. For example, and with respect to the base GAN 500, the time series simulation model training controller 204 may include an Adam optimizer that includes initial decay rate used when estimating the first moments (beta_1) set to 0.5 and learning rates set as 8e-6 and 1e-5 for the generator neural network 505 and the discriminator neural network 510, respectively. The model is optimized by minimizing the mean square error (MSE) for both the generator neural network 505 and the discriminator neural network 510, respectively and the gradient is normalized by clipping the gradient norm to 100 to prevent them from exploding. To prevent overfitting of the discriminator neural network 510, the training time series data set 625 may be randomly modified by adding gaussian noise and the “real” and “fake” labels are flipped 10% of the times. While specific values for weights are discussed, other values for weights may be used in other scenarios.

With respect to the coupled GAN 600, the time series simulation model training controller 204 may include an Adam optimizer that includes a beta_1=0.5 and a learning rate set as 1e-5 and 9e-5 for the generator neural network 605 and the discriminator neural network 610, respectively. The model may be optimized by minimizing the binary cross entropy loss for the discriminator neural network 610. The generator neural network 605 may be optimized by minimizing mean absolute error and binary cross entropy loss functions with equal weights. The gradients may be clipped by clipping the norm to 100 and to prevent overfitting of the discriminator neural network 610. The training time series data set 635 may be randomly modified by adding gaussian noise and the real and fake labels are flipped 10% of the times while training.

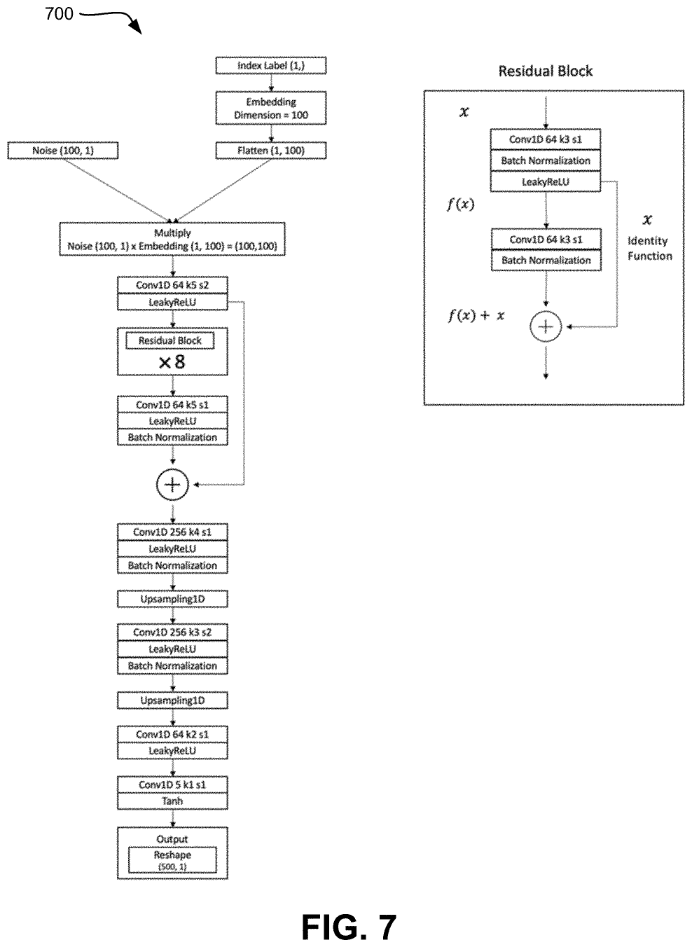

FIGS. 7, 8, 9, and 10 illustrate more specific workflows of training the base GAN and the coupled GAN. FIG. 7 illustrates an example workflow 700 of the trained generative neural network included in the base GAN 420 of FIG. 4. The input provided to the generative neural network is a gaussian noise along with a flattened embedding of the label associated with the selected data set. These two inputs are multiplied together, and the output may be provided to single dimension convolution layers with multiple neurons. In the illustrated example the convolution layers may include kernel size of (5,5) and with strides 2. The layer output is then passed through a LeakyReLU activation function. After the first convolution layer, residual blocks may be injected. In the illustrated embodiment eight residual blocks may be injected and may include LeakyReLU activated convolution layers, which may be set to hold 64 neurons, kernel size (3,3) and strides 1 with batch normalization and another similar convolution layer with only a batch normalized output. The output from these residual blocks may then passed through a series of convolutional layers and up-sampled, as illustrated in FIG. 7, before being passed to the final output layer with a hyperbolic tangent activation function. While a specific generative neural network for the base GAN is illustrated in FIG. 7, one of skill in the art will recognize that the generative neural network for the base GAN is not limited to this example and other generative neural networks may be implemented.

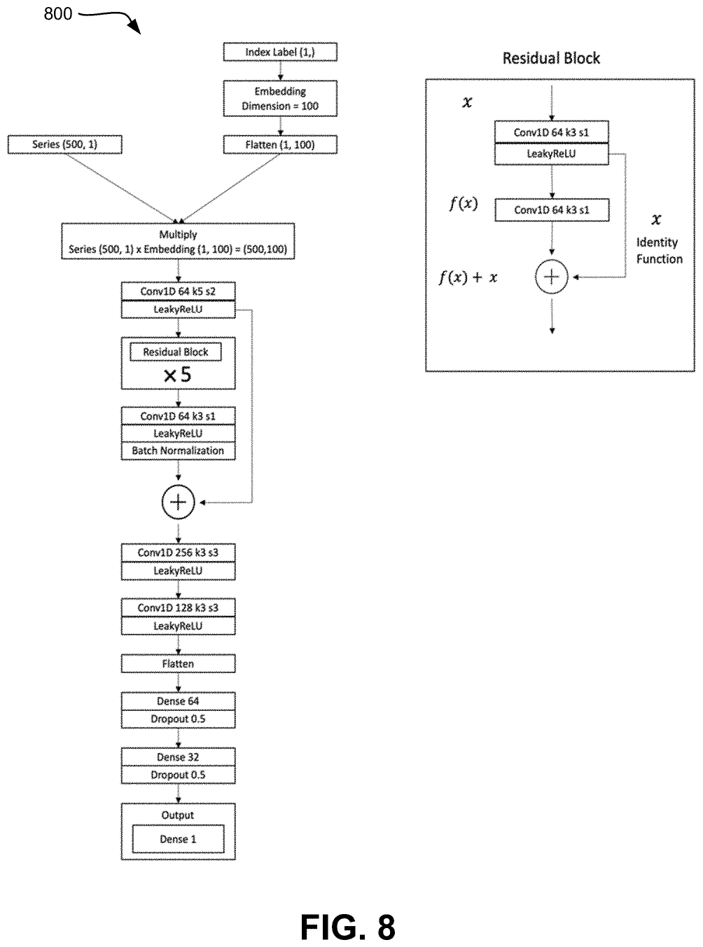

FIG. 8 illustrates an example workflow 800 of the trained discriminator neural network of the base GAN 420 of FIG. 4. The input provided to trained discriminator neural network is series of days (e.g., 500 days) or any other time period of the synthetic time series data set generated by the trained generator neural network of FIG. 7, which can be real or generated along with a flattened embedding of the label associated with the selected data set. These two inputs are multiplied together, and the output can then be fed to single dimension convolution layers with multiple neurons. In some examples, the kernel size may be (5,5) and strides may be 2. The layer output may then pass through a LeakyReLU activation function. After the first convolution layer, residual blocks (e.g., 5 residual blocks) may be injected that may include a LeakyReLU activated convolution layers, which may be set to hold 64 neurons, kernel size (3,3) and strides 1, and another similar convolution layer. The output is then passed to a series of single dimensional convolutional layers before it is flattened and passed through fully connected layers with a dropout rate that may be 0.5 but other rates may be contemplated. The discriminator neural network output may include a linear response generated by a single neuron dense layer. While a specific discriminator neural network for the base GAN is illustrated, one of skill in the art in possession of the present disclosure will recognize that the discriminator neural network for the base GAN is not limited to this example and other discriminator neural networks may be implemented.

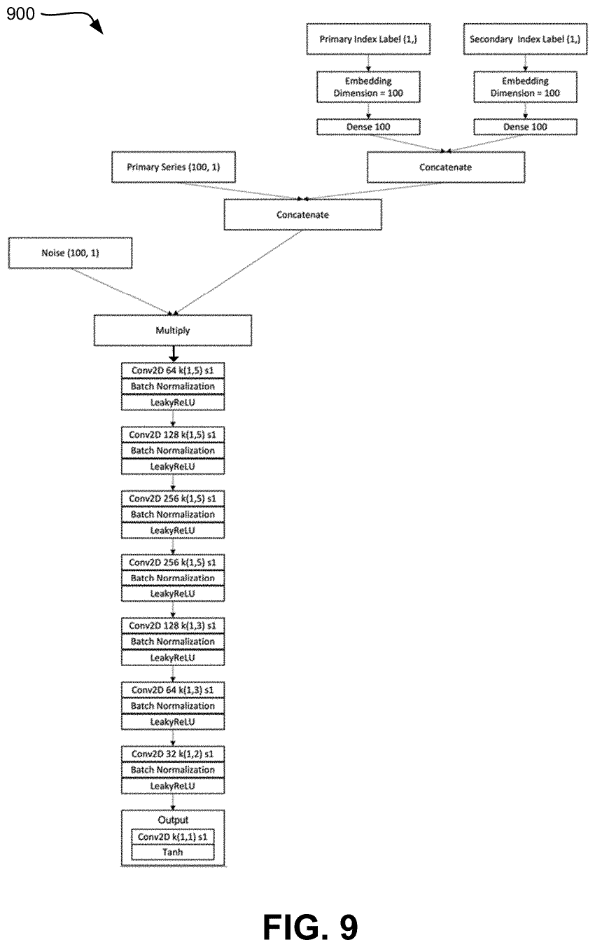

FIG. 9 illustrates a workflow 900 of the trained generative neural network included in the coupled GAN 430. The generative neural network of the coupled GAN 430 illustrated in FIG. 9 may require multiple inputs which need to be processed according to block 316 of method 300 before they can be supplied to the generative neural network. The labels of the first time series data set and the second time series data set may be passed through an embedding and dense layer before being concatenated. This concatenated output is further concatenated to the synthetic time series data set produced by the base GAN 420 for a time period (e.g., 100 days as illustrated) and the output from this step is multiplied to the Gaussian noise or some other substantially random number generated. The resulting multiplied tensor or generated time series data set may then pass through a series of two-dimensional convolution-batch Normalization-LeakyReLU blocks with decreasing kernel sizes and stride 1, according to the illustrated embodiment. The final output layer may include a two-dimensional convolution layer with kernel size, stride 1 and hyperbolic tangent activation function. As such, the generative neural network for the coupled GAN may learn to capture the trend dynamics and relationships between the pair of time series data sets and may attempt to generate the second selected time series data set accordingly. While a specific generative neural network for the coupled GAN is illustrated, one of skill in the art will recognize that the generative neural network for the coupled GAN is not limited to this example and other generative neural networks may be implemented.

FIG. 10 illustrates a workflow 1000 of the trained discriminator neural network included in the coupled GAN 430. The discriminator neural network of the coupled GAN 430 illustrated in FIG. 10 may require multiple inputs which need to be processed before they can be supplied to the discriminator neural network of the coupled GAN 430. For example, the labels of the first time series data set and the second time series data set may be passed through an embedding and dense layer before being concatenated. This concatenated output is further concatenated to the synthetic time series data set produced by the base GAN 420 for a time period (e.g., 100 days as illustrated) and the output from this step is multiplied to the synthetic time series data set generated by the generator neural network included in the coupled GAN 430 (e.g., the output of the workflow 900 of FIG. 9). The synthetic time series data set generated by the generator neural network may be for a time period (e.g., 100 days). The multiplied tensor or generated time series data set may then pass through a series of one-dimensional convolution-layer normalization-LeakyReLU blocks with decreasing kernel sizes except for the first block skipping layer normalization. Max pooling may be used in between the convolution blocks to down sample the outputs and prevent overfitting. The outputs may then pass through fully connected layers with layer normalization, ReLU activation and dropout of a value (e.g., 0.1) before a final single neuron dense output with sigmoid activation is produced. As such, the discriminator neural network included in the coupled GAN may learn how real selected time series data set will behave given the inputs and differentiates if the synthetic time series data set associated with the selected time series data set is indeed “real” or “fake”. While a specific discriminator neural network for the coupled GAN is illustrated, one of skill in the art will recognize that the discriminator neural network for the coupled GAN is not limited to this example and other discriminator neural networks may be implemented.

After the series of generated values is provided by the synthetic data generator 415 to a base GAN 420 in block 308, the method 300 may proceed to block 310 where the base GAN is operated with the series of generated values and the label. In various embodiments, at block 310, the time series simulation model controller 205 may operate such that the trained generator neural network included in the base GAN receives the series of generated values and the label and outputs a synthetic time series data set that is provided to the trained coupled GAN. While a trained generator neural network of the base GAN is described as providing a synthetic time series data set to the coupled GAN, in other embodiments, the base GAN may be replaced by a Monte Carlo simulation, a variation autoencoder, or time series data set simulator.

The method 300 may then proceed to block 312 where a data set of the data object is selected. In an embodiment, at block 312, the time series simulation model controller 205 may select one of the data sets included in the data object. In some embodiments, the data set selected may not be the data set that was used to generate the synthetic time series data set at the base GAN. For example, the data set 405a of FIG. 4 may be selected and data set 405n may have been selected to generate the synthetic time series data set for the base GAN. The selected time series data set may be associated with a label. The label may identify or otherwise describe the time series data set. The label may include a machine learning label.

The method 300 may then proceed to block 313 where a first series of generated values is generated. In an embodiment, at block 313, the time series simulation model controller 205 may generate a series of generated values similarly to block 306. In some examples, the series of generated values may include Gaussian noise. However, the series of generated values may include a series of generated values generated by any random number generator or pseudorandom number generator. The method 300 may then proceed to block 314 where the series of generated values, the machine learning label associated with the selected data set, the synthetic time series data set, and the label associated with the synthetic time series data set is inputted into the coupled GAN. In an embodiment, at block 314, the label associated with the selected time series data set may be provided to the coupled GAN. The coupled GAN may also receive the synthetic time series data set, the label associated with the synthetic time series data set, and the series of generated values. As illustrated at block 425 of FIG. 4, the synthetic data generator may generate a coupled GAN input based on the label associated with the selected time series data set, the synthetic time series data set, and the label associated with the synthetic time series data set, and the series of generated values. The coupled GAN input may be provided to the coupled GAN 430. For example, a flattened embedding of the synthetic time series data set label and the selected time series data set label may be concatenated into a concatenated label. The concatenated label may be concatenated with the synthetic time series data set to form the concatenated synthetic time series data set. The concatenated time series data set may be multiplied with the series of generated values to provide the coupled GAN input.

The method 300 may then proceed to block 316 where the coupled GAN runs. In an embodiment at block 316, the time series simulation model controller 205 runs the coupled GAN (e.g., the coupled GAN 430 of FIG. 4). In various embodiments, the trained generator neural network included in the coupled GAN 430 receives the coupled GAN input from block 425 and outputs a synthetic time series data set 435.

The method 300 may then proceed to decision block 318 where it is determined whether any other time series data sets included in the data object are remaining to be provided through the coupled GAN of the time series simulation machine learning model. If there are any remaining time series data sets (e.g., time series data sets 405a-405n) that have not been inputted into the coupled GAN 430, then the method 300 may proceed back to block 312 where an available time series data set is selected.

However, if at decision block 318 it is determined that all the time series data sets included in the data object have been processed by the coupled GAN, then the method 300 may proceed to block 320 where the synthetic time series data sets generated by the coupled GAN and the synthetic time series data sent generated by the base GAN may be merged into a composite synthetic data set. In an embodiment, at block 320, the time series simulation model controller 205 may merge the synthetic time series data sets into a composite synthetic data set. The time series simulation model controller 205 may merge the synthetic time series data sets according to the weights associated with the corresponding data sets. For example, the weights of the data sets 405a-405n may be used when merging the synthetic time series data sets into the composite synthetic time series data set. In various embodiments, the composite synthetic data set may provide the scenario 440 of FIG. 4.

The method 300 may proceed to block 322 where an action is performed using the composite synthetic data set. In embodiment, at block 322, the time series simulation model controller 205 may perform one or more synthetic time series actions. For example, the composite synthetic data set or any of the synthetic time series data sets included in the composite synthetic data set may be stored in the storage system 208 as the composite synthetic time series data set 216 and the synthetic time series data set 214, respectively. In other embodiments, the composite synthetic data set or any of the synthetic data sets included in the composite synthetic data set may be visualized by a user associated with the user computing device 102. The composite synthetic data set or any of the synthetic data sets included in the composite synthetic data set may be sent from the time series simulation computing device 104 via the network 108 to the user computing device 102 for visualization of the composite synthetic data set.

In various embodiments, the time series simulation model controller 205 may calculate one or more metrices, also referred to as properties (e.g., a property 445 of FIG. 4) using the composite synthetic data set. For example, the time series simulation model controller 205 in the portfolio analysis scenario may determine a return, a Sharpe ratio, an information ratio, or a drawdown among other metrics for that scenario. In the pharmaceutical scenario, the metric determined may include a drug efficacy or other metrics. In the battery scenario, the metric determined may include a cost per kilowatt hour or other metrics. In the climate scenario, the metric determined may include temperature or other metrics. While some actions are discussed above, one of skill in the art in possession of the present disclosure will recognize the systems and methods of the present disclosure are not limited to these actions and that other actions may be performed using the composite synthetic time series data set or any of the synthetic time series data sets generated by the couple GAN and still fall under the scope of the present disclosure.

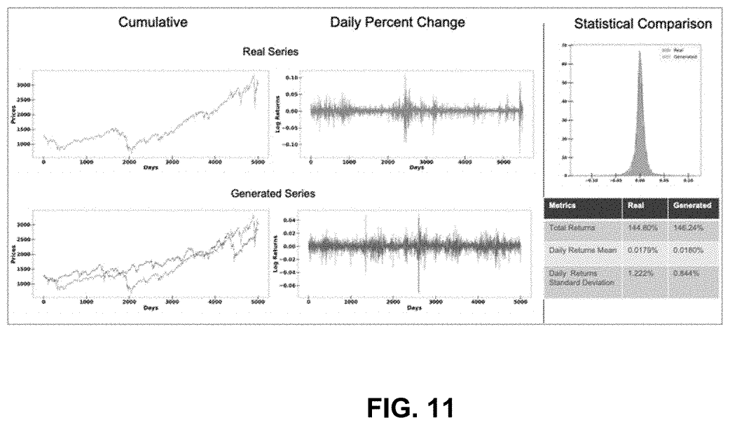

FIG. 11 illustrates the S&P 500 and a synthetic S&P 500 generated using the systems and method of the present disclosure and concatenated to get 20 years of daily returns. As illustrated by FIG. 11, the synthetic time series data for the synthetic S&P 500 mimics the behavior, but not the exact data points, of the real S&P 500. On the right side of the plots, statistical data is illustrated that demonstrates the broad behavior of the synthetic time series data set does not depart significantly from the real data, even though the synthetic time series data set visually looks different from the real data.

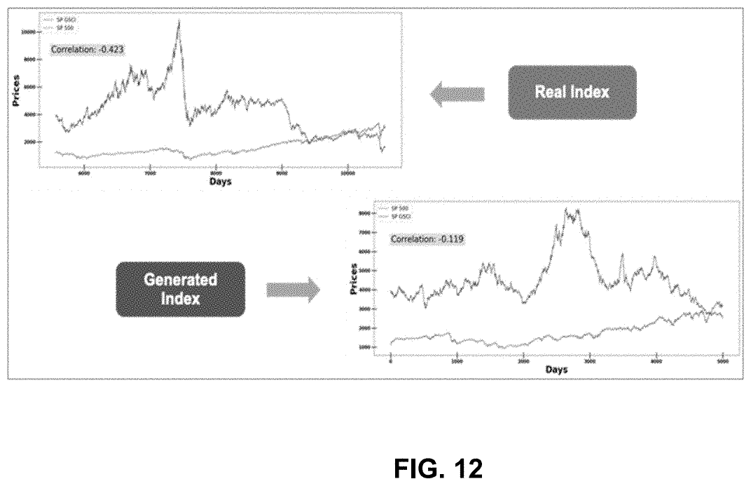

FIG. 12 illustrates a disassociation between two time series data sets generated independently using only the base GAN. While the correlation between generated benchmarks is −0.119, the real correlation is −0.423. As such, systems and methods of the present disclosure make improvements to single GAN systems and improvements to the other data simulation models discussed herein.

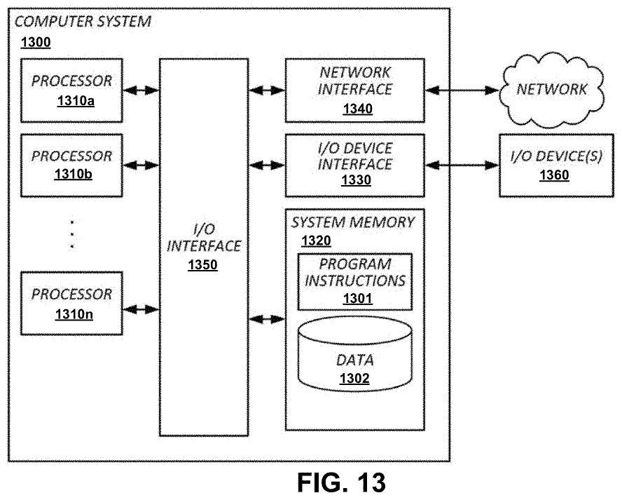

FIG. 13 is a diagram that illustrates an exemplary computing system 1300 in accordance with embodiments of the present technique. The user computing device 102 and the time series simulation computing devices 104 and 200, and the data object provider computing device 106 discussed above, may be provided by the computing system 1300. Various portions of systems and methods described herein, may include or be executed on one or more computing systems similar to computing system 1300. Further, processes and modules described herein may be executed by one or more processing systems similar to that of computing system 1300. Thus, the systems and methods of the present disclosure provide a robust solution to stress test the investment portfolios or other time series data sets, based on the proportion of each asset class assigned to the portfolio. This will allow the investment managers to better gauge the performance of the suggested portfolio prior to presenting to the prospect or client.

Computing system 1300 may include one or more processors (e.g., processors 1310a-1310n) coupled to system memory 1320, an input/output I/O device interface 1330, and a network interface 1340 via an input/output (I/O) interface 1350. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1300. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1320). Computing system 1300 may be a uni-processor system including one processor (e.g., processor 1310a), or a multi-processor system including any number of suitable processors (e.g., 1310a-1310n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1300 may include a plurality of computing devices (e.g., distributed computing systems) to implement various processing functions.

I/O device interface 1330 may provide an interface for connection of one or more I/O devices 1360 to computing system 1300. I/O devices may include devices that receive input (e.g., from a user) or output information (e.g., to a user). I/O devices 1360 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1360 may be connected to computing system 1300 through a wired or wireless connection. I/O devices 1360 may be connected to computing system 1300 from a remote location. I/O devices 1360 located on remote computing system, for example, may be connected to computing system 1300 via a network and network interface 1340.

Network interface 1340 may include a network adapter that provides for connection of computing system 1300 to a network. Network interface 1340 may facilitate data exchange between computing system 1300 and other devices connected to the network (e.g., the network 108). Network interface 1340 may support wired or wireless communication. The network may include an electronic communication network, such as the Internet, a local area network (LAN), a wide area network (WAN), a cellular communications network, or the like.

System memory 1320 may be configured to store program instructions 1301 or data 1302. Program instructions 1301 may be executable by a processor (e.g., one or more of processors 1310a-1310n) to implement one or more embodiments of the present techniques. Instructions 1301 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1320 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1320 may include a non-transitory computer readable storage medium that may have program instructions stored thereon that are executable by a computer processor (e.g., one or more of processors 1310a-1310n) to cause the subject matter and the functional operations described herein. A memory (e.g., system memory 1320) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1350 may be configured to coordinate I/O traffic between processors 1310a-1010n, system memory 1320, network interface 1340, I/O devices 1360, and/or other peripheral devices. I/O interface 1350 may perform protocol, timing, or other data transformations to convert data signals from one component (e.g., system memory 1320) into a format suitable for use by another component (e.g., processors 1310a-1310n). I/O interface 1350 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1300 or multiple computing systems 1300 configured to host different portions or instances of embodiments. Multiple computing systems 1300 may provide for parallel or sequential processing/execution of one or more portions of the techniques described herein.

Those skilled in the art will appreciate that computing system 1300 is merely illustrative and is not intended to limit the scope of the techniques described herein. Computing system 1300 may include any combination of devices or software that may perform or otherwise provide for the performance of the techniques described herein. For example, computing system 1300 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1300 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1300 may be transmitted to computing system 1300 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A method of time series data set simulation, comprising: obtaining, by a computing system, a first synthetic time series data set that is associated with a first machine learning label; inputting, by the computing system, the first machine learning label, the first synthetic time series data set, a second machine learning label, and a first series of generated values into a first generator neural network included in a first generative adversarial network; inputting, by the computing system, the first machine learning label, the first synthetic time series data set, the second machine learning label, a first real time series data set that is associated with the second machine learning label, and a second synthetic time series data set that is associated with the second machine learning label and that is outputted from the first generator neural network into a first discriminator neural network included in the first generative adversarial network; running, by the computing system, the first generative adversarial network until the second synthetic time series data set is determined to satisfy a first evaluation condition by the first discriminator neural network; generating, by the computing system, a time series simulation machine learning model that includes the first generative adversarial network that includes first model parameters that resulted in the first generative adversarial network producing the second synthetic time series data set that satisfied the evaluation condition; and storing, by the computing system, the time series simulation machine learning model in a storage system coupled to the computing system.
2. The method of embodiment 1, wherein the first synthetic time series data set is based on a second real time series data set.
3. The method of embodiment 1, wherein the first synthetic time series data set is obtained as an output of a second generative adversarial network.
4. The method of embodiment 3, wherein the time series simulation machine learning model includes the second generative adversarial network that includes second model parameters that resulted in the second generative adversarial network producing the first synthetic time series data set that satisfied a second evaluation condition.
5. The method of embodiment 1, wherein the inputting the first machine learning label, the first synthetic time series data set, the second machine learning label, and the first series of generated values into a first generator neural network included in the first generative adversarial network includes: generating, by the computing system, a concatenated machine learning label by concatenating the first machine learning label with the second machine learning label; generating, by the computing system, a concatenated first synthetic time series data set by concatenating the concatenated machine learning label with the first synthetic time series data set; generating, by the computing system, a first generator neural network input by multiplying the concatenated first synthetic time series data set with the first series of generated values; and inputting, by the computing system, the first generator neural network input into the first generator neural network of the first generative adversarial network.
6. The method of embodiment 1, wherein the inputting, the first machine learning label, the first synthetic time series data set, the second machine learning label, the first real time series data set that is associated with the second machine learning label, and the second synthetic time series data set that is associated with the second machine learning label and that is outputted from the first generator neural network into the first discriminator neural network included in the first generative adversarial network includes: generating, by the computing system, a concatenated machine learning label by concatenating the first machine learning label with the second machine learning label; generating, by the computing system, a concatenated first synthetic time series data set by concatenating the concatenated machine learning label with the first synthetic time series data set; generating, by the computing system, a concatenated second synthetic time series data set by concatenating the second synthetic time series data set and the first real time series data set; generating, by the computing system, a first discriminator neural network input using the concatenated first synthetic time series data set and the concatenated second synthetic time series data set; and inputting, by the computing system, the first discriminator neural network input into the first discriminator neural network.
7. The method of embodiment 1, further comprising: inputting, by the computing system, the first machine learning label and a second series of generated values into a second generator neural network included in a second generative adversarial network; inputting, by the computing system, the first machine learning label, a second real time series data set that is associated with the first machine learning label, and the first synthetic time series data set that is associated with the first machine learning label and that is outputted from the second generator neural network into a second discriminator neural network included in the second generative adversarial network; and running, by the computing system, the second generative adversarial network until the first synthetic time series data set is determined to satisfy a second evaluation condition by the second discriminator neural network, wherein the first synthetic time series data set that satisfies the second evaluation condition is outputted as the first synthetic time series data set that is obtained for the first generative adversarial network.
8. The method of embodiment 7, wherein the time series simulation machine learning model includes the second generative adversarial network that includes second model parameters that resulted in the second generative adversarial network producing the first synthetic time series data set that satisfied the second evaluation condition.
9. The method of embodiment 8, wherein the inputting the first machine learning label and the second series of generated values into the second generator neural network included in the second generative adversarial network includes: generating, by the computing system, a second generator neural network input by multiplying the first machine learning label that is flattened, embedded with the first series of generated values; and inputting the second generator neural network input into the second generator neural network.
10. The method of embodiment 1, further comprising: obtaining, by the computing system, a data object that includes a plurality of time series data sets; obtaining, by the computing system, a third synthetic time series data set that is associated with a third machine learning label, wherein the third machine learning label is associated with a first time series data set of the plurality of time series data sets; inputting, by the computing system, the third synthetic time series data set, the third machine learning label, a fourth machine learning label that is associated with a second time series data set of the plurality of time series data sets, and a third series of generated values in the time series simulation machine learning model that includes the first generative adversarial network that includes the first model parameters; running, by the computing system, the time series simulation machine learning model that includes running the first generative adversarial network with the third synthetic time series data set, the third series of generated values, the third machine learning label, and the fourth machine learning label; generating, by the computing system via the running of the time series simulation machine learning model, a synthetic second time series data set for the second time series data set; and storing, by the computing system, the synthetic second time series data set in the storage system.
11. The method of embodiment 10, further comprising: inputting, by the computing system, the third machine learning label and a second series of generated values into a second generator neural network included in a second generative adversarial network that is included in the time series simulation machine learning model and that includes second model parameters; and running, by the computing system, the second generator neural network to generate the third synthetic time series data set that is obtained for the first generative adversarial network.
12. The method of embodiment 10, further comprising: inputting, by the computing system, the third synthetic time series data set, the third machine learning label, a fifth machine learning label that is associated with a third time series data set of the plurality of time series data sets, and a fourth series of generated values in the time series simulation machine learning model that includes the first generative adversarial network including the first model parameters; running, by the computing system, the time series simulation machine learning model that includes running the first generative adversarial network with the third synthetic time series data set, the third machine learning label, the fifth machine learning label, and the fourth series of generated values; generating, by the computing system via the running of the time series simulation machine learning model, a synthetic third time series data set for the third time series data set; merging, by the computing system, the synthetic third time series data set and the synthetic second time series data set that results in a composite synthesized data set; and storing, by the computing system, the composite synthesized data set in the storage system.
13. The method of embodiment 12, further comprising: calculating, by the computing system and using the composite synthesized data set, one or more metrices.
14. The method of embodiment 12, wherein the merging the synthetic third time series data set and the synthetic second time series data set that results in the composite synthesized data set includes combining the synthetic third time series data set and the synthetic second time series data set based on a first weight associated with the synthetic third time series data set and a second weight based on the synthetic second time series data set.
15. A non-transitory, machine-readable medium storing instructions that, when executed by one or more processors, effectuate operations comprising: obtaining, by a computing system, a data object that includes a plurality of time series data sets; obtaining, by the computing system, a first synthetic time series data set that is associated with a first machine learning label, wherein the first machine learning label is associated with a first time series data set of the plurality of time series data sets; inputting, by the computing system, the first synthetic time series data set, the first machine learning label, a second machine learning label that is associated with a second time series data set of the plurality of time series data sets, and a first series of generated values in a time series simulation machine learning model that includes a first trained generative adversarial network that includes first model parameters; running, by the computing system, the time series simulation machine learning model that includes running a first generator neural network included in the first trained generative adversarial network with the first synthetic time series data set, the first machine learning label, the second machine learning label, and the first series of generated values; generating, by the computing system via the running of the time series simulation machine learning model, a synthetic second time series data set for the second time series data set; and storing, by the computing system, the synthetic second time series data set in a storage system.
16. The medium of embodiment 15, wherein the operations further comprise: inputting, by the computing system, the first machine learning label and a second series of generated values into a second generator neural network included in a second generative adversarial network that is included in the time series simulation machine learning model and that includes second model parameters; and running, by the computing system, the second generator neural network to generate the first synthetic time series data set that is obtained for the first generative adversarial network and that is a synthetic first time series data set for the first time series data set.
17. The medium of embodiment 15, wherein the operations further comprise: inputting, by the computing system, the first synthetic time series data set, the first machine learning label, a third machine learning label that is associated with a third time series data set of the plurality of time series data sets, and a second series of generated values in the time series simulation machine learning model that includes the first generative adversarial network that includes the first model parameters; running, by the computing system, the time series simulation machine learning model that includes running the first generator neural network included in the first generative adversarial network with the first synthetic time series data set, the first machine learning label, the third machine learning label, and the second series of generated values; generating, by the computing system via the running of the time series simulation machine learning model, a synthetic third time series data set for the third time series data set; merging, by the computing system, the synthetic third time series data set and the synthetic second time series data set that results in a composite synthesized data set; and storing, by the computing system, the composite synthesized data set in the storage system.
18. The medium of embodiment 17, wherein the operations further comprise: calculating, by the computing system and using the composite synthesized data set, one or more metrices.
19. The medium of embodiment 17, wherein the merging the synthetic third time series data set and the synthetic second time series data set that results in the composite synthesized data set includes combining the synthetic third time series data set and the synthetic second time series data set based on a first weight associated with the synthetic third time series data set and a second weight based on the synthetic second time series data set.
20. A method of time series data set simulation, comprising: obtaining, by a computing system, a data object that includes a plurality of time series data sets; obtaining, by the computing system, a first synthetic time series data set that is associated with a first machine learning label, wherein the first machine learning label is associated with a first time series data set of the plurality of time series data sets; inputting, by the computing system, the first synthetic time series data set, the first machine learning label, a second machine learning label that is associated with a second time series data set of the plurality of time series data sets, and a first series of generated values in a time series simulation machine learning model that includes a first trained generative adversarial network that includes first model parameters; running, by the computing system, the time series simulation machine learning model that includes running a first generator neural network included in the first trained generative adversarial network with the first synthetic time series data set, the first machine learning label, the second machine learning label, and the first series of generated values; generating, by the computing system via the running of the time series simulation machine learning model, a synthetic second time series data set for the second time series data set; and storing, by the computing system, the synthetic second time series data set in a storage system.

What is claimed is:

1. A method of time series data set simulation, comprising:
obtaining, by a computing system, a first synthetic time series data set that is associated with a first machine learning label;
inputting, by the computing system, the first machine learning label, the first synthetic time series data set, a second machine learning label, and a first series of generated values into a first generator neural network included in a first generative adversarial network;
inputting, by the computing system, the first machine learning label, the first synthetic time series data set, the second machine learning label, a first real time series data set that is associated with the second machine learning label, and a second synthetic time series data set that is associated with the second machine learning label and that is outputted from the first generator neural network into a first discriminator neural network included in the first generative adversarial network;
running, by the computing system, the first generative adversarial network until the second synthetic time series data set is determined to satisfy a first evaluation condition by the first discriminator neural network;
generating, by the computing system, a time series simulation machine learning model that includes the first generative adversarial network that includes first model parameters that resulted in the first generative adversarial network producing the second synthetic time series data set that satisfied the evaluation condition; and
storing, by the computing system, the time series simulation machine learning model in a storage system coupled to the computing system.

2. The method of claim 1, wherein the first synthetic time series data set is based on a second real time series data set.

3. The method of claim 1, wherein the first synthetic time series data set is obtained as an output of a second generative adversarial network.

4. The method of claim 3, wherein the time series simulation machine learning model includes the second generative adversarial network that includes second model parameters that resulted in the second generative adversarial network producing the first synthetic time series data set that satisfied a second evaluation condition.

5. The method of claim 1, wherein the inputting the first machine learning label, the first synthetic time series data set, the second machine learning label, and the first series of generated values into a first generator neural network included in the first generative adversarial network includes:
generating, by the computing system, a concatenated machine learning label by concatenating the first machine learning label with the second machine learning label;
generating, by the computing system, a concatenated first synthetic time series data set by concatenating the concatenated machine learning label with the first synthetic time series data set;
generating, by the computing system, a first generator neural network input by multiplying the concatenated first synthetic time series data set with the first series of generated values; and
inputting, by the computing system, the first generator neural network input into the first generator neural network of the first generative adversarial network.

6. The method of claim 1, wherein the inputting, the first machine learning label, the first synthetic time series data set, the second machine learning label, the first real time series data set that is associated with the second machine learning label, and the second synthetic time series data set that is associated with the second machine learning label and that is outputted from the first generator neural network into the first discriminator neural network included in the first generative adversarial network includes:
generating, by the computing system, a concatenated machine learning label by concatenating the first machine learning label with the second machine learning label;
generating, by the computing system, a concatenated first synthetic time series data set by concatenating the concatenated machine learning label with the first synthetic time series data set;
generating, by the computing system, a concatenated second synthetic time series data set by concatenating the second synthetic time series data set and the first real time series data set;
generating, by the computing system, a first discriminator neural network input using the concatenated first synthetic time series data set and the concatenated second synthetic time series data set; and
inputting, by the computing system, the first discriminator neural network input into the first discriminator neural network.

7. The method of claim 1, further comprising:
inputting, by the computing system, the first machine learning label and a second series of generated values into a second generator neural network included in a second generative adversarial network;
inputting, by the computing system, the first machine learning label, a second real time series data set that is associated with the first machine learning label, and the first synthetic time series data set that is associated with the first machine learning label and that is outputted from the second generator neural network into a second discriminator neural network included in the second generative adversarial network; and
running, by the computing system, the second generative adversarial network until the first synthetic time series data set is determined to satisfy a second evaluation condition by the second discriminator neural network, wherein the first synthetic time series data set that satisfies the second evaluation condition is outputted as the first synthetic time series data set that is obtained for the first generative adversarial network.

8. The method of claim 7, wherein the time series simulation machine learning model includes the second generative adversarial network that includes second model parameters that resulted in the second generative adversarial network producing the first synthetic time series data set that satisfied the second evaluation condition.

9. The method of claim 8, wherein the inputting the first machine learning label and the second series of generated values into the second generator neural network included in the second generative adversarial network includes:
generating, by the computing system, a second generator neural network input by multiplying the first machine learning label that is flattened, embedded with the first series of generated values; and
inputting the second generator neural network input into the second generator neural network.

10. The method of claim 1, further comprising:
obtaining, by the computing system, a data object that includes a plurality of time series data sets;
obtaining, by the computing system, a third synthetic time series data set that is associated with a third machine learning label, wherein the third machine learning label is associated with a first time series data set of the plurality of time series data sets;
inputting, by the computing system, the third synthetic time series data set, the third machine learning label, a fourth machine learning label that is associated with a second time series data set of the plurality of time series data sets, and a third series of generated values in the time series simulation machine learning model that includes the first generative adversarial network that includes the first model parameters;
running, by the computing system, the time series simulation machine learning model that includes running the first generative adversarial network with the third synthetic time series data set, the third series of generated values, the third machine learning label, and the fourth machine learning label;
generating, by the computing system via the running of the time series simulation machine learning model, a synthetic second time series data set for the second time series data set; and
storing, by the computing system, the synthetic second time series data set in the storage system.

11. The method of claim 10, further comprising:
inputting, by the computing system, the third machine learning label and a second series of generated values into a second generator neural network included in a second generative adversarial network that is included in the time series simulation machine learning model and that includes second model parameters;
and
running, by the computing system, the second generator neural network to generate the third synthetic time series data set that is obtained for the first generative adversarial network.

12. The method of claim 10, further comprising:
inputting, by the computing system, the third synthetic time series data set, the third machine learning label, a fifth machine learning label that is associated with a third time series data set of the plurality of time series data sets, and a fourth series of generated values in the time series simulation machine learning model that includes the first generative adversarial network including the first model parameters;
running, by the computing system, the time series simulation machine learning model that includes running the first generative adversarial network with the third synthetic time series data set, the third machine learning label, the fifth machine learning label, and the fourth series of generated values;
generating, by the computing system via the running of the time series simulation machine learning model, a synthetic third time series data set for the third time series data set;
merging, by the computing system, the synthetic third time series data set and the synthetic second time series data set that results in a composite synthesized data set; and
storing, by the computing system, the composite synthesized data set in the storage system.

13. The method of claim 12, further comprising:
calculating, by the computing system and using the composite synthesized data set, one or more metrices.

14. The method of claim 12, wherein the merging the synthetic third time series data set and the synthetic second time series data set that results in the composite synthesized data set includes combining the synthetic third time series data set and the synthetic second time series data set based on a first weight associated with the synthetic third time series data set and a second weight based on the synthetic second time series data set.

15. A non-transitory, machine-readable medium storing instructions that, when executed by one or more processors, effectuate operations comprising:
obtaining, by a computing system, a data object that includes a plurality of time series data sets;
obtaining, by the computing system, a first synthetic time series data set that is associated with a first machine learning label, wherein the first machine learning label is associated with a first time series data set of the plurality of time series data sets;
inputting, by the computing system, the first synthetic time series data set, the first machine learning label, a second machine learning label that is associated with a second time series data set of the plurality of time series data sets, and a first series of generated values in a time series simulation machine learning model that includes a first trained generative adversarial network that includes first model parameters;
running, by the computing system, the time series simulation machine learning model that includes running a first generator neural network included in the first trained generative adversarial network with the first synthetic time series data set, the first machine learning label, the second machine learning label, and the first series of generated values;
generating, by the computing system via the running of the time series simulation machine learning model, a synthetic second time series data set for the second time series data set; and
storing, by the computing system, the synthetic second time series data set in a storage system.

16. The medium of claim 15, wherein the operations further comprise:
inputting, by the computing system, the first machine learning label and a second series of generated values into a second generator neural network included in a second generative adversarial network that is included in the time series simulation machine learning model and that includes second model parameters;
and
running, by the computing system, the second generator neural network to generate the first synthetic time series data set that is obtained for the first generative adversarial network and that is a synthetic first time series data set for the first time series data set.

17. The medium of claim 15, wherein the operations further comprise:
inputting, by the computing system, the first synthetic time series data set, the first machine learning label, a third machine learning label that is associated with a third time series data set of the plurality of time series data sets, and a second series of generated values in the time series simulation machine learning model that includes the first generative adversarial network that includes the first model parameters;
running, by the computing system, the time series simulation machine learning model that includes running the first generator neural network included in the first generative adversarial network with the first synthetic time series data set, the first machine learning label, the third machine learning label, and the second series of generated values;
generating, by the computing system via the running of the time series simulation machine learning model, a synthetic third time series data set for the third time series data set;
merging, by the computing system, the synthetic third time series data set and the synthetic second time series data set that results in a composite synthesized data set; and
storing, by the computing system, the composite synthesized data set in the storage system.

18. The medium of claim 17, wherein the operations further comprise:
calculating, by the computing system and using the composite synthesized data set, one or more metrices.

19. The medium of claim 17, wherein the merging the synthetic third time series data set and the synthetic second time series data set that results in the composite synthesized data set includes combining the synthetic third time series data set and the synthetic second time series data set based on a first weight associated with the synthetic third time series data set and a second weight based on the synthetic second time series data set.

20. A method of time series data set simulation, comprising:
obtaining, by a computing system, a data object that includes a plurality of time series data sets;
obtaining, by the computing system, a first synthetic time series data set that is associated with a first machine learning label, wherein the first machine learning label is associated with a first time series data set of the plurality of time series data sets;
inputting, by the computing system, the first synthetic time series data set, the first machine learning label, a second machine learning label that is associated with a second time series data set of the plurality of time series data sets, and a first series of generated values in a time series simulation machine learning model that includes a first trained generative adversarial network that includes first model parameters;
running, by the computing system, the time series simulation machine learning model that includes running a first generator neural network included in the first trained generative adversarial network with the first synthetic time series data set, the first machine learning label, the second machine learning label, and the first series of generated values;
generating, by the computing system via the running of the time series simulation machine learning model, a synthetic second time series data set for the second time series data set; and
storing, by the computing system, the synthetic second time series data set in a storage system.
